(19) United States
(12) Patent Application Publication
(10) Pub. No.: US 2019/0310277 A1
(43) Pub. Date: Oct. 10, 2019

(54) LABORATORY ANALYSIS SYSTEM WITH IMPROVED SAMPLE PIPETTING

(71) Applicant: Siemens Healthcare Diagnostics Products GmbH, Marburg (DE)

(72) Inventors: David Solbach, Frankfurt (DE); Markus Buchwald, Eschborn (DE)

(21) Appl. No.: 16/375,753

(22) Filed: Apr. 4, 2019

(30) Foreign Application Priority Data
Apr. 5, 2018 (EP) EP 18165860

(51) Int. Cl. G01N 35/04; G01N 15/05; G01N 35/10; G01N 21/51

(52) U.S. Cl. CPC G01N 35/04; G01N 15/05; G01N 35/00603; G01N 21/51; G01N 35/1072

(57) ABSTRACT

The invention lies in the field of laboratory automation and relates to a laboratory analysis system 100, in which a plurality of analysis devices 1 and an image recording station 101 are connected to a transportation apparatus 102 for sample vessels and in which sample-vessel-specific information items, which are established in the image recording station 101, are used for controlling the pipetting apparatuses in the analysis devices 1.

### CROSS REFERENCE TO RELATED APPLICATION

This claims priority to European Patent Application No. EP 18165860.0, filed Apr. 5, 2018, which is hereby incorporated by reference herein in its entirety for all purposes.

### FIELD

The invention lies in the field of laboratory automation and relates to a laboratory analysis system, in which a plurality of analysis devices and an image recording station are connected to a transportation apparatus for sample vessels and in which sample-vessel-specific information items, which are established in the image recording station, are used for controlling the pipetting apparatuses in the analysis devices.

### BACKGROUND

In modern laboratory automation, automated analysis devices, as find routine use in analytics, forensics, microbiology and clinical diagnostics and as are each able to carry out a multiplicity of detection reactions and analyses with a multiplicity of samples, are connected to a process line in order to obtain a higher sample throughput while maintaining the laboratory flexibility at the same time. As a rule, such a laboratory analysis system comprises a plurality of similar or different analysis devices, which are all connected to a transportation apparatus of sample vessels. A sample vessel with a sample that should be used to carry out a plurality of tests is successively transported to the analysis devices along the transportation apparatus, the required tests being carried out in said analysis devices. Then, a portion of the sample is removed from the sample vessel in each analysis device with the aid of a pipetting apparatus and subjected to the required test method or methods.

Typically, an automated analysis device houses various automatically operating apparatuses for spatial transfer of measuring cells, reaction containers and reagent liquid containers, such as, e.g., transfer arms with a gripper function, conveyor belts or rotatable transport wheels, and apparatuses for transferring liquids, such as, e.g., pipetting apparatuses, under one device housing. Further, the devices comprise a control unit that, by means of appropriate software, is able to plan and work through the work steps for the desired analyses in largely autonomous fashion.

Many of the analysis methods employed in such analysis devices operating in automated fashion are based on optical methods. Measuring systems based on photometric (e.g., turbidimetric, nephelometric, fluorometric or luminometric) or radiometric measurement principles are particularly widespread. These methods facilitate qualitative and quantitative detection of analytes in liquid samples without having to provide for additional separation steps. Clinically relevant parameters, such as the concentration or activity of an analyte, are often determined by virtue of an aliquot of a bodily fluid of a patient being mixed, either simultaneously or successively, with one or more test reagents in a reaction vessel to form an assay mix, as a result of which a biochemical reaction is put into motion, which brings about a measurable change in an optical property of the reaction assay. Photometry examines and exploits the attenuation of a luminous flux during the passage through an absorbing and/or scattering medium. Different photometric measuring methods are used depending on the triggered biochemical or biophysical reaction, said measuring methods facilitating the measurement of a turbid liquid assay mix.

The measurement result, in turn, is transmitted into a memory unit by the measuring system and evaluated therein. Subsequently, the analysis device supplies a user with sample-specific measurement values by way of an output medium such as, for example, a monitor, a printer or a network connection. If the analysis device is part of a laboratory analysis system, provision can also be made for the sample-specific measurement values to be transferred to the central control unit of the laboratory analysis system via a data line and to be supplied to a user from there via an output medium.

There are laboratory analysis systems that comprise an image recording station that, as a separate module, is likewise connected to the transportation apparatus for the sample vessels. The image recording station with the associated image evaluation apparatus is usually provided at the start of the transportation path, and it serves to record images of sample vessels filled with sample liquid. An image recording device suitable for such an image recording station is described for example in WO-A1-03/060483.

EP-A2-2151690 describes a laboratory analysis system, which comprises:

a. a multiplicity of analysis devices, wherein each analysis device has a control unit, at least one pipetting apparatus with a pipetting needle for taking a sample liquid volume from a sample vessel and an analysis apparatus for analyzing a sample liquid;

b. an image recording station for recording images of sample vessels filled with sample liquid, and an associated image evaluation apparatus; and

c. a transportation apparatus for sample vessels, all analysis devices and the image recording station being connected thereto.

In the laboratory analysis system according to EP-A2-2151690, an image of a sample vessel is used to establish the fill level and, ultimately, the overall sample volume and the presence or lack of a clot as sample-vessel-specific parameters in the image recording station. On the basis of these sample-vessel-specific parameters, the central control unit of the laboratory analysis system, which is linked to all analysis devices, to the image recording station and to the transportation apparatus for sample vessels, establishes whether sufficient sample liquid is present for the analyses envisaged for the specific sample and generates corresponding analysis tasks, which are stored with the sample vessel identification number. If a sample vessel now enters one of the analysis devices, a check as to whether an analysis task is present is carried out and an instruction relating to the sample volume to be taken contained in the analysis task is implemented by virtue of a pipetting needle being inserted into the sample vessel and a predetermined volume being extracted.

A problem is that sufficient suitable sample material may not be present at the instant of the sample extraction in an analysis device despite the determination of the aforementioned sample-vessel-specific parameters (fill level, overall sample volume, presence or lack of a clot) in the image recording station and the analysis tasks then generated in the central control unit of the laboratory analysis system (which ultimately contain the instruction as to whether, and how much, sample volume should be extracted from a specific sample vessel by a pipetting apparatus of an analysis device). Various layers are present in the sample vessel, particularly in the case of sedimented blood samples or blood samples mixed with separating agents; these layers are not all equally suitable for the desired analyses or the uptake of these layers into the pipetting needle should be prevented because doing so risks a blockage in the pipetting needle. Both the take-up of unsuitable sample material, which may ultimately lead to an incorrect determination, and a blockage of the pipetting needle, which requires a complicated washing procedure or, in the worst case, the replacement of the pipetting needle and hence results in an outage of the affected analysis device, reduce the sample throughput of the laboratory analysis system.

### SUMMARY

It is therefore desirable to modify a laboratory analysis system of the type set forth at the outset in such a way that a reduction in the sample throughput as a result of pipetting errors in the sample extraction in an analysis device is avoided.

This object is achieved by virtue of sample-vessel-specific information items, which are established in the image evaluation apparatus of the image recording station, being transferred to one, more or all analysis devices of the laboratory analysis system and by virtue of sample-vessel-specific parameters for the operation of the pipetting apparatus when taking a sample liquid volume from a specific sample vessel being established in the respective analysis device on the basis of these sample-vessel-specific information items. In particular, the object is achieved by virtue of the fill level height of the sample liquid and/or, provided this is present, the height of separating layers within the sample liquid being established for each sample vessel as sample-vessel-specific parameters in the image recording station and said sample-vessel-specific parameters being transferred to the control unit of the respective analysis device, wherein, for each individual sample vessel, the maximum perpendicular travel of the pipetting needle then is established for positioning the pipetting needle in an extraction position. This ensures that only the sample liquid suitable for an analysis is taken from each sample vessel and hence ensures that a blockage of the pipetting needle is avoided.

Thus, the present invention relates to a laboratory analysis system, comprising:

a. a multiplicity of analysis devices, wherein each analysis device has a control unit, at least one pipetting apparatus with a vertically displaceable pipetting needle for taking a sample liquid volume from a sample vessel and at least one analysis apparatus for analyzing a sample liquid;

b. an image recording station for recording images of sample vessels filled with sample liquid, and an associated image evaluation apparatus; and

c. a transportation apparatus for sample vessels, all analysis devices and the image recording station being connected thereto.

The laboratory analysis system according to the invention further comprises a data transmission apparatus, by means of which sample-vessel-specific information items are transferable from the image evaluation apparatus to the control unit of at least one analysis device, wherein the control unit of the at least one analysis device, to which the sample-vessel-specific information items are transferable from the image evaluation apparatus, is configured in such a way that it controls a method including the following steps:
evaluating the sample-vessel-specific information items from the image evaluation apparatus and establishing one or more sample-vessel-specific parameters for the operation of the pipetting apparatus when taking a sample liquid volume from a specific sample vessel, and
controlling the operation of the pipetting apparatus when taking a sample liquid volume from a specific sample vessel by applying the established sample-vessel-specific parameters,

wherein the sample-vessel-specific information items that are transferable from the image evaluation apparatus to the control unit of the at least one analysis device are selected from the group of fill level height of the sample liquid and height of separating layers within the sample liquid and wherein a parameter that is established for the operation of the pipetting apparatus when taking a sample liquid volume from a specific sample vessel is the maximum perpendicular travel of the pipetting needle for the purposes of positioning the pipetting needle in an extraction position.

The maximum immersion depth into the sample liquid is predetermined by way of setting the maximum perpendicular travel of the pipetting needle, specific to each sample vessel, for the purposes of positioning the pipetting needle in an extraction position. What this achieves is that the penetration of the pipetting needle into layers, such as a clot layer which contains clumpy material or a separating agent layer which contains practically no patient sample, is avoided, which, in turn, ensures that sample constituents that are not analyzable are not extracted.

The typical layering in sample vessels (e.g., in blood sampling tubes) which were filled with whole blood and treated differently is shown in FIG. 1.

For the purposes of obtaining serum, the whole blood is filled into a tube without an anticoagulant such that the blood coagulates after some time. As a result of being left alone or centrifuged, the solid constituents of the clot sediment at the base of the tube and form the so-called clot layer. The serum is situated above the clot layer as a supernatant. Particularly if a laboratory analysis system according to the invention comprises one or more analysis devices that are provided for the analysis of serum samples, the image recording station is advantageously provided to record images of sample vessels filled with coagulated, sedimented blood and the sample-vessel-specific information item, which is transferable from the image evaluation apparatus to the control unit of the at least one analysis device, is the height of the clot layer. The sample-vessel-specific information item about the height of the clot layer is then used in the control unit of the analysis device to set the maximum perpendicular travel of the pipetting needle for the specific sample vessel, and hence to set the maximum immersion depth for the pipetting needle. The maximum perpendicular travel of the pipetting needle is chosen in such a way that the pipetting needle tip is positioned above the clot layer in the extraction position, i.e., when sample liquid is taken from the sample vessel.

For the purposes of obtaining plasma, the whole blood is filled into a tube with an anticoagulant such that the blood is made incoagulable. As a result of being left alone or centrifuged, the solid cell constituents of the blood sediment at the base of the tube and form a lower thicker layer made of erythrocytes and, lying there above, a thinner layer made of leukocytes and blood platelets, the so-called buffy coat layer. The plasma is situated, as a supernatant, above the buffy coat layer. Particularly if a laboratory analysis system according to the invention comprises one or more analysis devices that are provided for the analysis of plasma samples, the image recording station is advantageously provided for recording images of sample vessels filled with sedimented blood that is made incoagulable and the sample-vessel-specific information item, which is transferable from the image evaluation apparatus to the control unit of the at least one analysis device, is the height of the buffy coat layer. The sample-vessel-specific information about the height of the buffy coat layer is then used in the control unit of the analysis device to set the maximum perpendicular travel of the pipetting needle for the specific sample vessel and hence the maximum immersion depth for the pipetting needle. The maximum perpendicular travel of the pipetting needle is chosen in such a way that the pipetting needle tip is positioned above the buffy coat layer in the extraction position, i.e., when sample liquid is taken from the sample vessel.

Additionally, use is often made of separating agents, e.g., separating gels, when serum or plasma is obtained. These are mixed with the whole blood sample and, post sedimentation, form a stable separating agent layer between serum and clot or between plasma and buffy coat layer. Therefore, the image recording station in the aforementioned laboratory analysis systems is advantageously also provided for recording images of sample vessels filled with sedimented blood that was mixed with a separating agent, and the sample-vessel-specific information item, which is transferable from the image evaluation apparatus to the control unit of the at least one analysis device, is the height of the separating agent layer. Then, the sample-vessel-specific information item about the height of the separating agent layer is used in the control unit of the analysis device in order to set the maximum perpendicular travel of the pipetting needle for the specific sample vessel and hence the maximum immersion depth for the pipetting needle. The maximum perpendicular travel of the pipetting needle is chosen in such a way that the pipetting needle tip is positioned above the separating agent layer in the extraction position, i.e., when sample liquid is taken from the sample vessel.

The image recording station may contain one or more cameras that take one or more images of each (transparent) sample vessel. An image evaluation apparatus, which comprises image processing and image evaluation software, is used to analyze each image and the fill level height of the sample liquid in a sample vessel and—should separating layers have been identified—the height of separating layers are established within the sample liquid.

In one embodiment of the laboratory analysis system according to the invention, the data transmission apparatus, by means of which sample-vessel-specific information items are transferable from the image evaluation apparatus to the control unit of the at least one analysis device, is a direct link between the image evaluation apparatus and the control unit of the analysis device.

However, alternatively, provision can also be made for the data transmission apparatus, by means of which sample-vessel-specific information items are transferable from the image evaluation apparatus to the control unit of at least one analysis device, to comprise a central control unit, which is linked to all analysis devices, to the image recording station and to the transportation apparatus for sample vessels. Such a central control unit can be one or more computers with appropriate software, for example.

Further subject matter of the present invention relates to an automated analysis device, which is adapted in such a way that it is suitable for inclusion in a laboratory analysis system according to the invention. An analysis device according to the invention comprises a control unit, at least one pipetting apparatus with a vertically displaceable pipetting needle for taking a sample liquid volume from a sample vessel, at least one analysis apparatus for analyzing a sample liquid and a connector for connecting to a transportation apparatus for sample vessels. The control unit has a connector, e.g., an interface, for a data transmission apparatus, by means of which sample-vessel-specific information items are transferable from an image evaluation apparatus to the control unit of the analysis device, and said control unit is configured in such a way that it controls a method including the following steps:
evaluating the sample-vessel-specific information items from the image evaluation apparatus and establishing one or more sample-vessel-specific parameters for the operation of the pipetting apparatus when taking a sample liquid volume from a specific sample vessel, and
controlling the operation of the pipetting apparatus when taking a sample liquid volume from a specific sample vessel by applying the established sample-vessel-specific parameters,

wherein the sample-vessel-specific information items that are transferable from the image evaluation apparatus to the control unit of the analysis device are selected from the group of fill level height of the sample liquid and height of separating layers within the sample liquid and wherein a parameter that is established for the operation of the pipetting apparatus when taking a sample liquid volume from a specific sample vessel is the maximum perpendicular travel of the pipetting needle for the purposes of positioning the pipetting needle in an extraction position.

Preferably, the control unit of the analysis device is configured in such a way that the evaluation of the sample-vessel-specific information item from the image evaluation apparatus and the establishment of one or more sample-vessel-specific parameters for the operation of the pipetting apparatus when taking a sample liquid volume from a specific sample vessel comprises the evaluation of the height of the clot layer, the height of the buffy coat layer or the height of the separating agent layer and the establishment of the height of the extraction position when taking a sample liquid volume from a specific sample vessel.

Likewise preferably, the control unit of the analysis device is configured in such a way that the maximum perpendicular travel of the pipetting needle for the positioning of the pipetting needle in an extraction position from a specific sample vessel is chosen in such a way that the extraction position lies above the height of the clot layer, the height of the buffy coat layer or the height of the separating agent layer in the specific sample vessel.

### BRIEF DESCRIPTION OF THE DRAWINGS

The invention will be explained below on the basis of a drawing.

In the drawing:

FIG. 1 shows sample vessels with sample liquids;

FIG. 2 shows an automated analysis device 1 according to the invention; and

FIG. 3 shows a laboratory analysis system 100 according to the invention.

Identical parts have been provided with the same reference signs in all figures.

### DETAILED DESCRIPTION

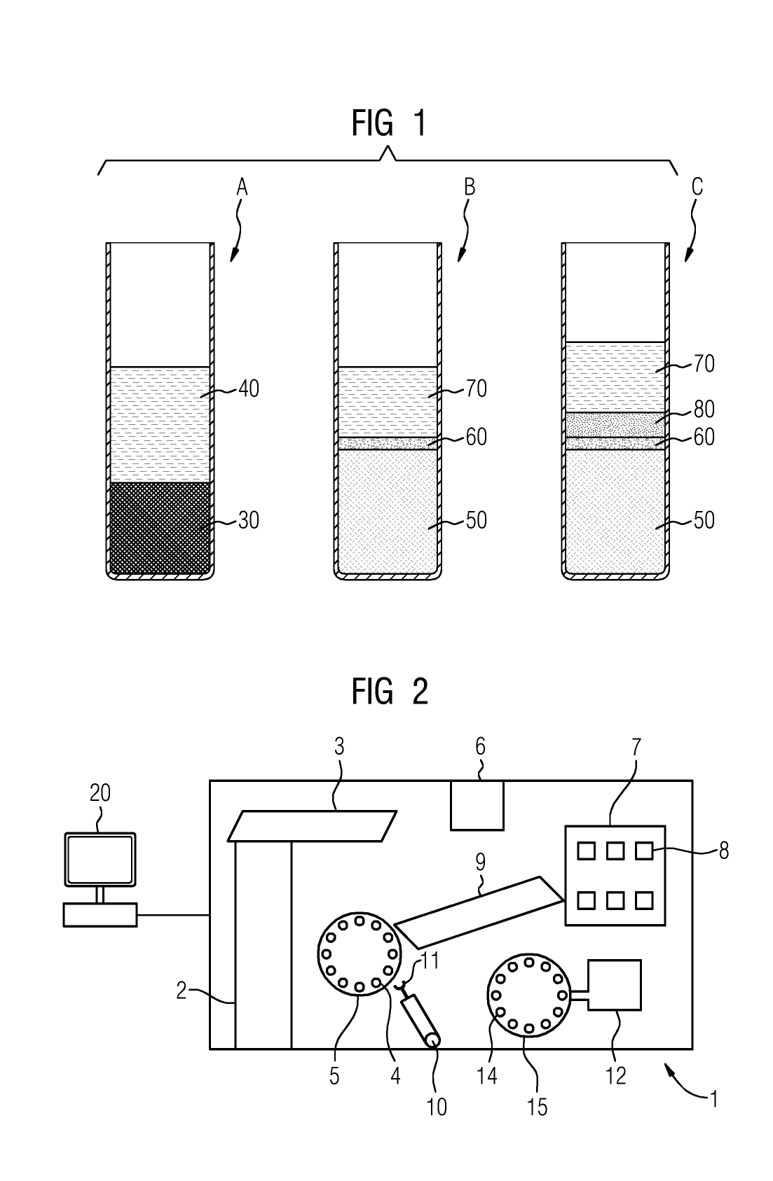

FIG. 1 is a schematic illustration of three sample vessels (A, B, C) containing treated whole blood, which forms different layers according to the treatment, said layers being separated by phase boundaries. Sample vessel A contains an anticoagulant-free and therefore clotted whole blood sample, which was briefly centrifuged. The solid constituents sediment on the base of the tube and form the so-called clot layer 30. As a supernatant, the serum 40 is situated above the clot layer. In order to ensure a take-up of serum 40 and in order to reliably preclude a removal of material from the clot layer 30, a height above the height of the clot layer 30 has to be chosen as a maximum immersion depth of a pipetting needle. Sample vessel B contains an anticoagulated whole blood sample that was briefly centrifuged. The cellular constituents sediment on the base of the tube and form a first layer of erythrocytes 50 and a thinner layer, lying there over, made of leukocytes and platelets, the so-called buffy coat layer 60. As a supernatant, the plasma 70 is situated above the buffy coat layer 60. In order to ensure a take-up of plasma 70 and in order to reliably preclude a removal of material from the buffy coat layer 60 or from the erythrocyte layer 50, a height above the height of the buffy coat layer 60 has to be chosen as a maximum immersion depth of a pipetting needle. Sample vessel C contains an anticoagulated whole blood sample that was mixed with a separating gel and briefly centrifuged. The cellular constituents sediment at the base of the tube and form a first layer of erythrocytes 50 and a thinner buffy coat layer 60 lying there over. A layer made of separating gel 80 is situated between the buffy coat layer 60 and the supernatant made of plasma 70. In order to ensure a take-up of plasma 70 and in order to reliably preclude a removal of material from the separating gel layer 80, the buffy coat layer 60 or from the erythrocyte layer 50, a height above the height of the separating gel layer 80 has to be chosen as a maximum immersion depth of a pipetting needle.

FIG. 2 is a schematic illustration of an automated analysis device 1 with some components contained therein. Here, only the most important components are illustrated in much-simplified fashion in order to explain the basic function of the automated analysis device 1, without presenting the individual parts of each component in detail in this case.

The automated analysis device 1 is embodied to carry out very different analyses of blood plasma, blood serum or other bodily fluids in a fully automated manner, without activities of a user being required to this end. Instead, necessary interventions of a user are restricted to servicing or repair and refill work, for example, if cuvettes have to be refilled or liquid containers have to be replaced.

The patient samples (primary samples) are fed into the automated analysis device 1 on carriages, not illustrated in any more detail, by way of a supply rail 2. Information items in respect of the analyses to be carried out for each sample may be transferred by means of barcodes attached to the sample vessels, for example, said barcodes being read in the automated analysis device 1 or being transmitted to the analysis device 1 by way of a laboratory information system. With the aid of a first pipetting apparatus 3 that is fastened to a transfer arm, sample aliquots are taken from the sample vessels by means of a vertically displaceable pipetting needle. The sample aliquots are supplied to cuvettes, likewise not illustrated in any more detail, which are arranged in receptacle positions 4 of a rotatable incubation appliance 5 whose temperature is controlled to 37° C. The cuvettes are taken from a cuvette storage container 6.

Reagent vessels 8 with different reagent liquids are stored in the reagent vessel storage container 7, which is cooled to approximately 8-10° C. Reagent liquid is taken from a reagent vessel 8 by means of the pipetting needle of a second pipetting apparatus 9 and said reagent liquid is added into the cuvette, which already contains the sample aliquot, for the purposes of providing a reaction assay. The cuvette with the assay mix is transported by a transfer arm 10 with a clamping gripper 11 from the incubation appliance 5 to a receptacle position 14 of the rotatable receptacle apparatus 15 for the photometric measuring station 12, where the attenuation of the reaction assay is measured.

The entire process is controlled by a control unit 20, such as a computer connected via a data line, for example, assisted by a multiplicity of further electronic circuits and microprocessors, not illustrated in any more detail, within the automated analysis device 1 and its components.

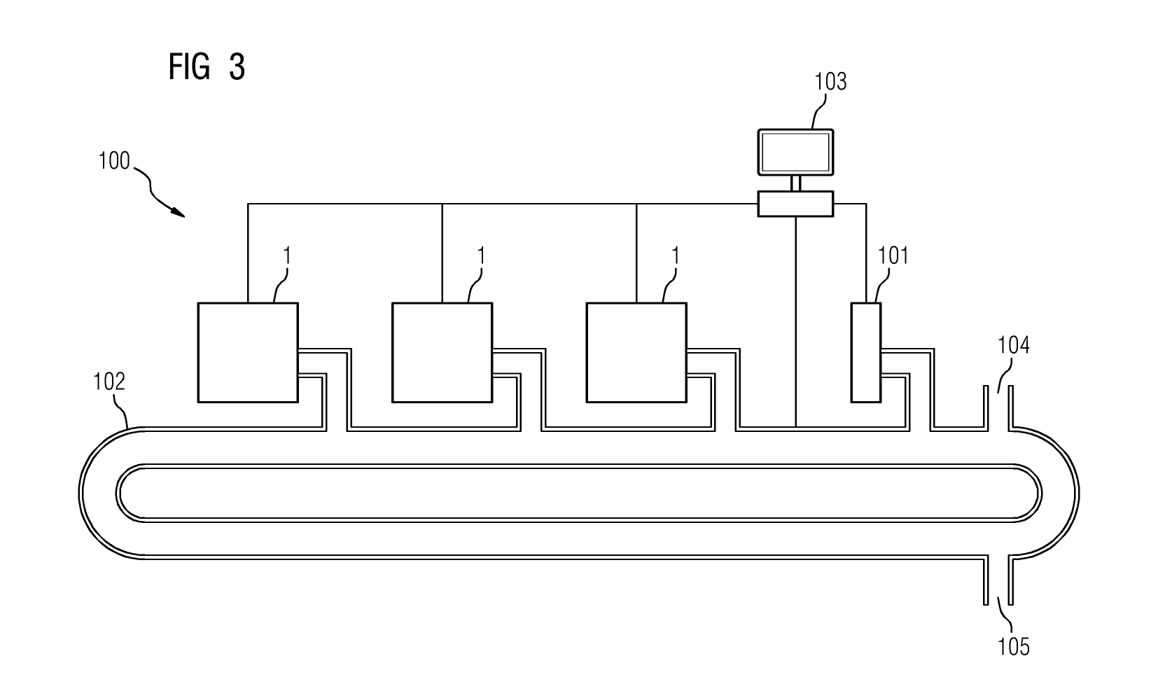

FIG. 3 shows a laboratory analysis system 100 according to the invention with three analysis devices 1, an image recording station 101 and a transportation apparatus 102 for sample vessels, to which all analysis devices 1 and the image recording station 101 are connected. Further, the laboratory analysis system 100 comprises a central control unit 103 in the form of a computer, which is linked to all essential components of the laboratory analysis system. By way of a supply station 104, carriages or frames, in which one or more sample vessels are arranged and which are not illustrated in any more detail, are supplied to the transportation apparatus 102. The carriages with the sample vessels are transported on a conveyor belt of the transportation apparatus 102, initially in the direction of the image recording station 101. In the image recording station 101, the barcodes, which are attached to the transparent sample vessels, are read with the aid of a barcode scanner and a camera is used to record at least one image of each liquid-filled sample vessel. Each image is analyzed using an image evaluation apparatus, which comprises image processing and image evaluation software, and the fill level height of the sample liquid in a sample vessel and -provided separating layers were identified—the heights of separating layers within the sample liquid are established.

The established fill level height of the sample liquid in a sample vessel and—provided separating layers were identified—the heights of the separating layers within the sample liquid are transferred for each sample vessel of the image recording station 101 to the central control unit 103 via a data line, said central control unit in turn transmitting these sample-vessel-specific data together with analysis tasks to one or more of the analysis devices 1.

After the identification and the optical analysis of the sample vessels in the image recording station 101, the carriages with the sample vessels are returned to the conveyor belt of the transportation apparatus 102 and transported on in the direction of the analysis devices 1. The carriages with the sample vessels are supplied to an analysis device 1 by way of a supply rail. Initially, the barcode of each sample vessel is read in the analysis device 1, and a check is carried out as to what analysis tasks and what sample-vessel-specific information items from the image evaluation apparatus of the image recording station 101 are present in the control unit 20 of the analysis device 1. Taking account of device-specific variables, the sample-vessel-specific information items from the image evaluation apparatus are used to establish how the pipetting apparatus must be operated in order to ensure that only desired sample material (plasma or serum) is taken during the take-up of sample liquid and that an uptake of unwanted material from other layers is reliably excluded. To this end, the maximum perpendicular travel of the pipetting needle is calculated as an operating parameter for the pipetting apparatus in order to set the maximum immersion depth of the pipetting needle to a height above the height of the uppermost disturbance layer. Subsequently, a desired sample volume is taken from the sample vessel with the aid of the pipetting apparatus with application of the previously established operating parameter and said sample volume is processed further in the analysis device 1. After the sample aliquots have been taken, the carriage with the sample vessels is returned to the conveyor belt of the transportation apparatus 102 and transported on in the direction of further analysis devices 1 or in the direction of an exit station 105.

### LIST OF REFERENCE SIGNS

1 Analysis device
2 Supply rail
3 Pipetting apparatus
4 Receptacle position
5 Incubation appliance
6 Cuvette storage container
7 Reagent vessel storage container
8 Reagent vessel
9 Pipetting apparatus
10 Transfer arm
11 Clamping gripper
12 Measuring station
14 Receptacle position
15 Receptacle apparatus
20 Control unit
30 Clot layer
40 Serum
50 Erythrocyte layer
60 Buffy coat layer
70 Plasma
80 Separating gel layer
100 Laboratory analysis system
101 Image recording station
102 Transportation apparatus
103 Central control unit
104 Supply station
105 Exit station

1. A laboratory analysis system (100), comprising
a. a multiplicity of analysis devices (1), wherein each analysis device (1) has a control unit (20), at least one pipetting apparatus (3) with a vertically displaceable pipetting needle for taking a sample liquid volume from a sample vessel and at least one analysis apparatus (12) for analyzing a sample liquid;
b. an image recording station (101) for recording images of sample vessels filled with sample liquid, and an associated image evaluation apparatus; and
c. a transportation apparatus (102) for sample vessels, all analysis devices (1) and the image recording station (101) being connected thereto,
characterized in that the laboratory analysis system (100) further comprises a data transmission apparatus, by means of which sample-vessel-specific information items are transferable from the image evaluation apparatus to the control unit (20) of at least one analysis device (1) and wherein the control unit (20) of the at least one analysis device (1), to which the sample-vessel-specific information items are transferable from the image evaluation apparatus, is configured in such a way that it controls a method including the following steps:
evaluating the sample-vessel-specific information items from the image evaluation apparatus and establishing one or more sample-vessel-specific parameters for the operation of the pipetting apparatus (3) when taking a sample liquid volume from a specific sample vessel, and
controlling the operation of the pipetting apparatus (1) when taking a sample liquid volume from a specific sample vessel by applying the established sample-vessel-specific parameters,
wherein the sample-vessel-specific information items that are transferable from the image evaluation apparatus to the control unit (20) of the at least one analysis device (1) are selected from the group of fill level height of the sample liquid and height of separating layers within the sample liquid and wherein a parameter that is established for the operation of the pipetting apparatus (3) when taking a sample liquid volume from a specific sample vessel is the maximum perpendicular travel of the pipetting needle for the purposes of positioning the pipetting needle in an extraction position.

2. The laboratory analysis system (100) as claimed in claim 1, wherein the image recording station (101) is provided for recording images of sample vessels filled with coagulated, sedimented blood and the sample-vessel-specific information item that is transferable from the image evaluation apparatus to the control unit (20) of the at least one analysis device (1) is the height of the clot layer (30).

3. The laboratory analysis system (100) as claimed in claim 1, wherein the image recording station (101) is provided for recording images of sample vessels filled with sedimented blood that has been made incoagulable and the sample-vessel-specific information item that is transferable from the image evaluation apparatus to the control unit (20) of the at least one analysis device (1) is the height of the buffy coat layer (60).

4. The laboratory analysis system (100) as claimed in claim 1, wherein the image recording station (101) is provided for recording images of sample vessels filled with sedimented blood that has been mixed with a separating agent and the sample-vessel-specific information item that is transferable from the image evaluation apparatus to the control unit (20) of the at least one analysis device (1) is the height of the separating agent layer (80).

5. The laboratory analysis system (100) as claimed in any one of claims 2 to 4, wherein the maximum perpendicular travel of the pipetting needle for the purposes of positioning the pipetting needle in an extraction position from a specific sample vessel is chosen in such a way that the extraction position lies above the height of the clot layer (30), the buffy coat layer (60) or the separating agent layer (80) in the specific sample vessel.

6. The laboratory analysis system (100) as claimed in any one of the preceding claims, wherein the data transmission apparatus, by means of which sample-vessel-specific information items are transferable from the image evaluation apparatus to the control unit (20) of the at least one analysis device (1), is a direct link between the image evaluation apparatus and the control unit (20) of the analysis device (1).

7. The laboratory analysis system (100) as claimed in any one of claims 1 to 5, wherein the data transmission apparatus, by means of which sample-vessel-specific information items are transferable from the image evaluation apparatus to the control unit (20) of at least one analysis device (1), comprises a central control unit (103), which is linked to all analysis devices (1), to the image recording station (101) and to the transportation apparatus (102) for sample vessels.

8. An automated analysis device (1) with a control unit (20), with at least one pipetting apparatus (3) with a vertically displaceable pipetting needle for taking a sample liquid volume from a sample vessel, with at least one analysis apparatus (12) for analyzing a sample liquid and with a connector for connecting a transportation apparatus (102) for sample vessels, characterized in that the control unit (20) further has a connector for a data transmission apparatus, by means of which sample-vessel-specific information items are transferable from an image evaluation apparatus to the control unit (20) of the analysis device (1), and the control unit (20) is configured in such a way that it controls a method including the following steps:
evaluating the sample-vessel-specific information items from the image evaluation apparatus and establishing one or more sample-vessel-specific parameters for the operation of the pipetting apparatus (3) when taking a sample liquid volume from a specific sample vessel, and
controlling the operation of the pipetting apparatus (3) when taking a sample liquid volume from a specific sample vessel by applying the established sample-vessel-specific parameters,
wherein the sample-vessel-specific information items that are transferable from the image evaluation apparatus to the control unit (20) of the analysis device (1) are selected from the group of fill level height of the sample liquid and height of separating layers within the sample liquid and wherein a parameter that is established for the operation of the pipetting apparatus (3) when taking a sample liquid volume from a specific sample vessel is the maximum perpendicular travel of the pipetting needle for the purposes of positioning the pipetting needle in an extraction position.

9. The automated analysis device (1) as claimed in claim 8, wherein the evaluation of the sample-vessel-specific information items from the image evaluation apparatus and the establishment of one or more sample-vessel-specific parameters for the operation of the pipetting apparatus (3) when taking a sample liquid volume from a specific sample vessel comprises the evaluation of the height of the clot layer (30), the height of the buffy coat layer (60) or the height of the separating agent layer (80) and the establishment of the height of the extraction position when taking a sample liquid volume from a specific sample vessel.

10. The automated analysis device (1) as claimed in claim 9, wherein the maximum perpendicular travel of the pipetting needle for the positioning of the pipetting needle in an extraction position from a specific sample vessel is chosen in such a way that the extraction position lies above the height of the clot layer (30), the height of the buffy coat layer (60) or the height of the separating agent layer (80) in the specific sample vessel.
